(19) United States
(12) Patent Application Publication
(10) Pub. No.: US 2012/0073686 A1
(43) Pub. Date: Mar. 29, 2012

(54) CONTROL VALVE ASSEMBLY FOR FAUCET AND FAUCET USING THE SAME

(76) Inventor: Tsai-Chen YANG, Taichung City (TW)

(21) Appl. No.: 12/912,821

(22) Filed: Oct. 27, 2010

(30) Foreign Application Priority Data
Sep. 24, 2010 (TW) 099218451

(51) Int. Cl. F16K 11/078

(52) U.S. Cl. 137/625.4

(57) ABSTRACT

A control valve assembly for a faucet of the present invention includes a main body, a mixing valve and a controller. The main body has a first inlet passage, a second inlet passage, a mixing room and a lateral outlet. The first inlet passage and the second inlet passage communicate with the mixing room. The lateral outlet is located on a side surface of the main body. The lateral outlet communicates with the mixing room. The mixing valve is used for adjusting a ratio between the fluxes of the first inlet passage and the second inlet passage. The controller is operated for controlling the mixing valve. Therefore, the inlets and the outlet are not gathered on the bottom of the main body. The structure of the faucet is simplified.

### BACKGROUND OF THE INVENTION

1. Field of the Invention

The present invention relates to a faucet and a control valve of the faucet.

2. Description of the Prior Art

Some faucets are used for mixing two flows, such as hot water and cold water. The faucet has a control valve which is able to control the ratio between the flow rates of the flows. Conventional faucet, such as the faucet disclosed in TW M330395, TW M386415 or TW M386416, has two inlets and at least an outlet. The inlets and the outlet are located on the bottom of a control valve of the faucet. As such, flow passages in the faucet are complicated. The faucet is difficult to be processed.

The present invention is, therefore, arisen to obviate or at least mitigate the above mentioned disadvantages.

### SUMMARY OF THE INVENTION

The main object of the present invention is to provide a control valve which has no outlet located on the bottom of the control valve.

To achieve the above and other objects, a control valve assembly for a faucet of the present invention includes a main body, a lateral outlet, a mixing vale and a controller. The main body has a first inlet passage, a second inlet passage, a mixing room and a lateral outlet. The inlet passages communicate with the mixing room individually. The lateral outlet is located on a side surface of the main body. The lateral outlet communicates with the mixing room. The mixing valve is used for adjusting a ratio of a flux of water flowing into the mixing room via the first inlet passage to a flux of water flowing into the mixing room via the second inlet passage. The controller is operated for controlling the mixing valve.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a first embodiment of the present invention;

FIG. 2 is a profile showing a first embodiment of the present invention;

FIG. 3 is a profile of another viewpoint of a first embodiment of the present invention;

FIG. 4 is a profile showing a second embodiment of the present invention;

FIG. 5 is a breakdown drawing showing a third embodiment of the present invention;

FIG. 6 is a profile showing a third embodiment of the present invention.

### DETAILED DESCRIPTION OF THE PREFERRED EMBODIMENTS

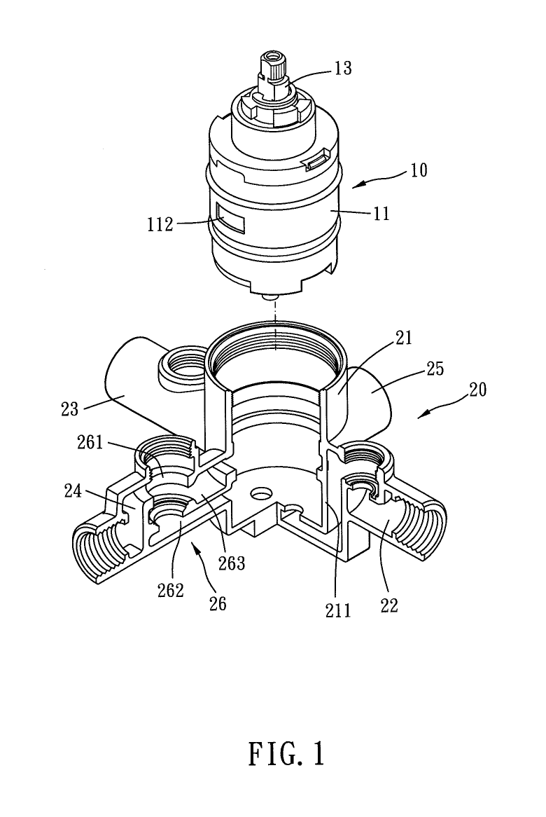

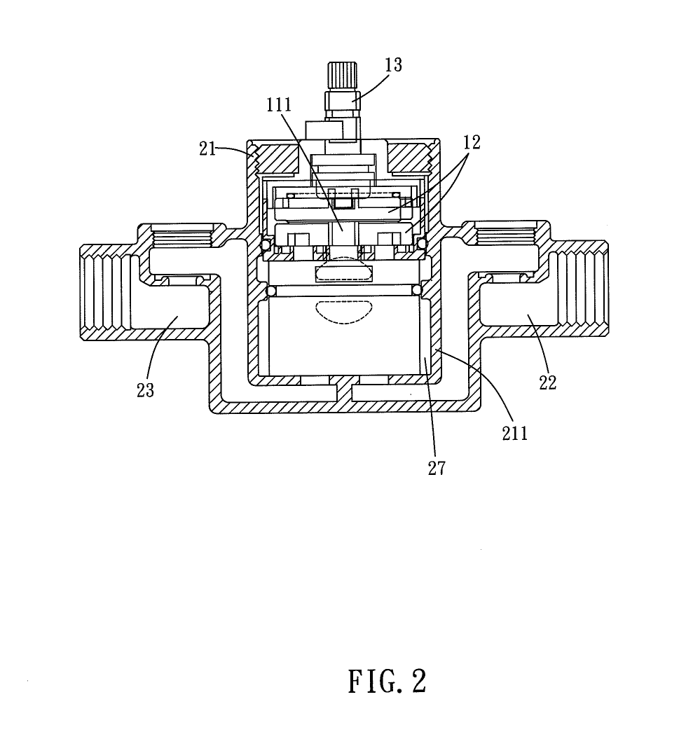

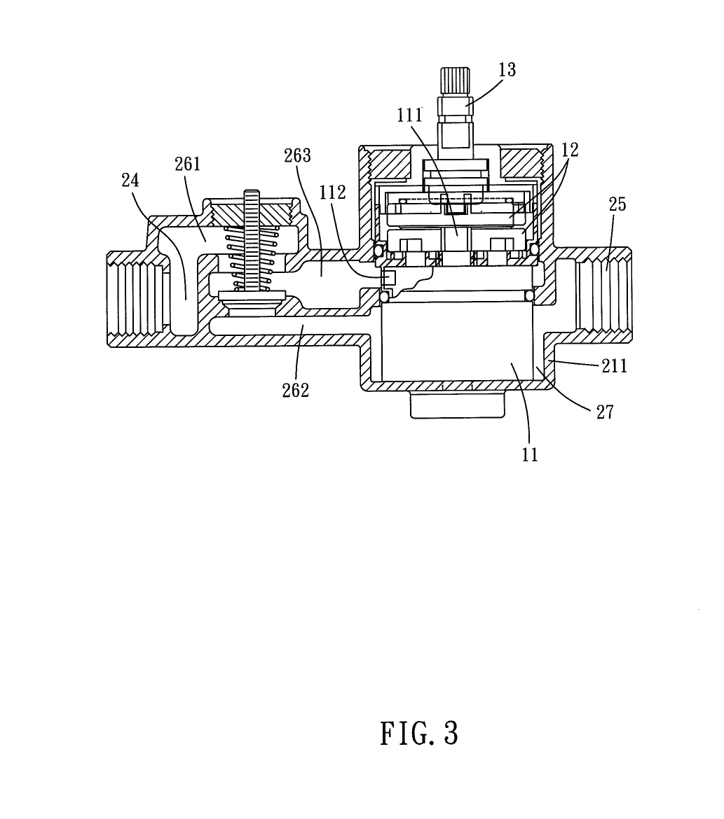

Please refer to FIG. 1 to FIG. 3 for a first embodiment of the present invention. The faucet of the present embodiment includes a control valve assembly 10 and a multi-way pipe 20.

The control valve assembly includes a main body 11, a mixing valve 12 and a controller 13. The main body 11 has a first inlet passage, a second inlet pipe, a mixing room 111 and a lateral outlet 112. Preferably, two guiding tubes may be disposed in the main body 11. The first inlet passage and the second inlet passage are defined by the guiding tubes individually. The first inlet passage and the second inlet passage are individually communicated with the mixing room 111 by the mixing valve 12. The first inlet passage has a first inlet. The second inlet passage has a second inlet. The first inlet and the second inlet are located on a bottom of the main body 11. The lateral outlet 112 is located on a side surface of the main body 11. The lateral outlet 112 communicates with the mixing room 111.

The mixing valve 12 is used for adjusting a ratio of a flux of water flowing into the mixing room via the first inlet passage to a flux of water flowing into the mixing room via the second inlet passage. The controller 13 is operated for controlling the mixing valve 12. More specifically, the mixing valve 12 may have a static portion and a rotary portion. Openings corresponding to the first inlet passage and the second inlet passage are defined by the static portion. A mixing hole corresponding to the openings is defined by the rotary portion. The rotary portion is rotatable so as to selectively cover the openings. As such, the ratio between the fluxes is adjustable. The controller 13 and the rotary portion are in an operative relationship, so that the rotary portion can be driven by the controller 13.

The multi-way pipe 20 has a containing unit 21, two enter pipes 22, 23, a first exit pipe 24, a second exit pipe 25 and an outflow controlling valve 26. The control valve assembly 10 is positioned in the containing unit 21. The enter pipes 22, 23 communicate with the first inlet passage and the second inlet passage individually, more specifically, with the first inlet and the second inlet individually. In other words, the enter pipes 22, 23 are located on the bottom of the containing unit 21. The outflow control valve 26 includes a first channel 261, a second channel 262 and a control valve unit 263. The control valve unit 263 communicates with the lateral outlet 112. The control valve unit 263 opens one of the first channel 261 and the second channel 262, closing the other one of the first channel 261 and the second channel 262 selectively. The first channel 261 communicates with the first exit pipe 24. The second channel communicates with the second exit pipe 25. Preferably, the containing unit 21 includes a lower containing unit 211. The lower containing unit 211 is located beneath the lateral outlet 122. An annular space 27 is defined by the lower containing unit 211 and the main body 11 of the control valve assembly. The annular space 27 communicates with the second channel 262 and the second exit pipe 25.

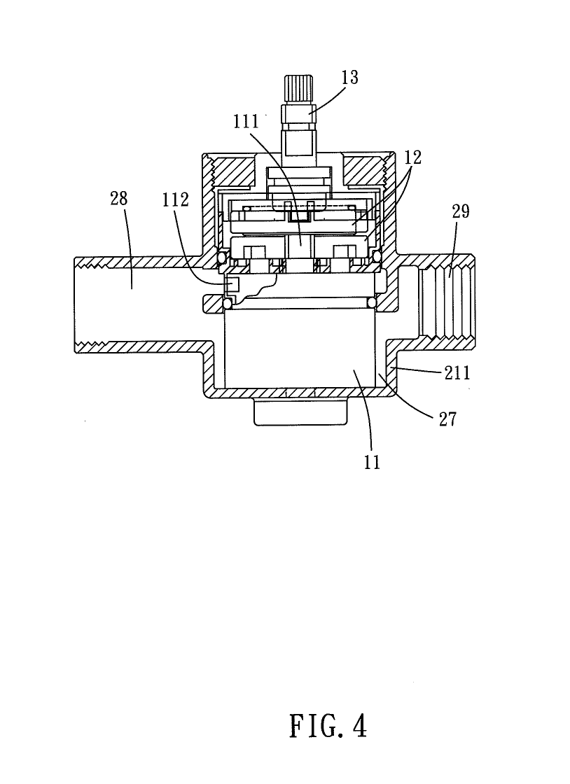

Please refer to FIG. 4. In a second embodiment of the present invention, the multi-way pipe may include the containing unit 21, the enter pipes 22, 23, a first exit end 28 and a second exit end 29. The main difference between the multi-way pipes of the first embodiment and the second embodiment is that the multi-way pipe 20 of the second embodiment has no outflow control valve to be disposed therein. The first exit end 28 communicates with the lateral outlet 112. The second exit end 29 is communicated with the first exit end 28 by the annular space 27.

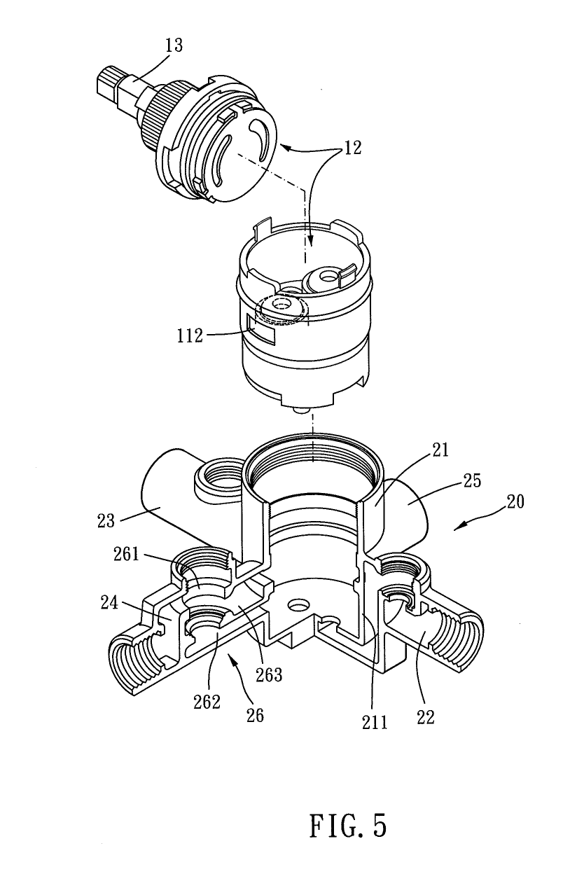

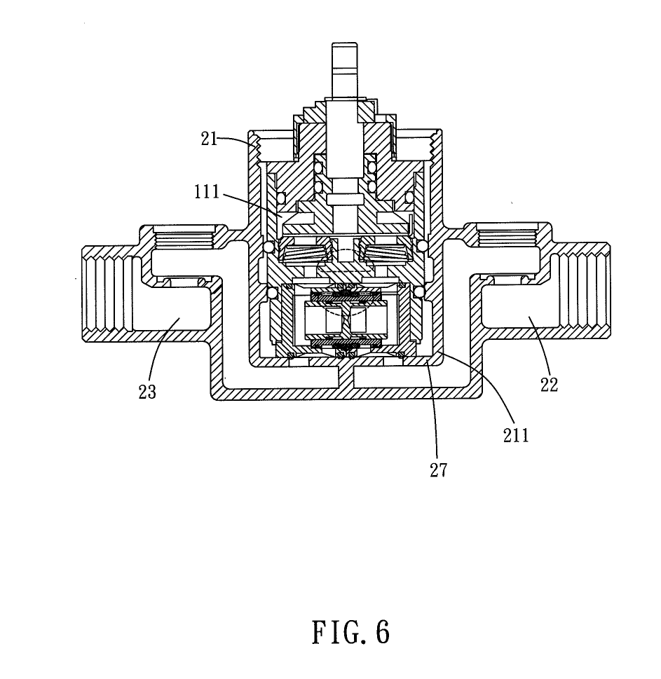

Please refer to FIG. 5 and FIG. 6. In a third embodiment of the present invention, the mixing valve 12 of the control valve assembly 10 may have a different structure to the mixing valve 12 in the first embodiment of the present invention. However, the mixing valve still has a rotary portion. The rotary portion is operated by the controller 13 so as to adjust the ratio between the fluxes.

Accordingly, the lateral outlet is located on the side surface of the main body, communicating with the mixing room directly. Pipes, passages or channels are not gathered on the bottom of the control valve assembly. The structure of the multi-way pipe is simplified. As such, the faucet of the present invention is easier to be processed.

What is claimed is:

1. A control valve assembly for a faucet, comprising:
a main body, having a first inlet passage, a second inlet passage, a mixing room and a lateral outlet, the inlet passages communicating with the mixing room individually, the lateral outlet being located on a side surface of the main body, the lateral outlet communicating with the mixing room;
a mixing valve, used for adjusting a ratio of a flux of water flowing into the mixing room via the first inlet passage to a flux of water flowing into the mixing room via the second inlet passage;
a controller, being operated for controlling the mixing valve.

2. The control valve assembly of claim 1, wherein the first inlet passage has a first inlet, the second inlet passage has a second inlet, the first inlet and the second inlet are located on a bottom of the main body.

3. A faucet, comprising the control valve assembly of claim 1, the faucet further comprising:
a multi-way pipe, having a containing unit, two enter pipes, a first exit pipe, a second exit pipe and an outflow controlling valve, the control valve assembly being positioned in the containing unit, the enter pipes communicating with the first inlet passage and the second inlet passage individually, the outflow controlling valve comprising a first channel, a second channel and a control valve unit, the control valve unit communicating with the lateral outlet, the control valve unit selectively opening one of the first channel and the second channel, the control valve unit closing the other one of the first channel and the second channel, the first channel communicating with the first exit pipe, the second channel communicating with the second exit pipe.

4. The faucet of claim 3, wherein the first inlet passage has a first inlet, the second inlet passage has a second inlet, the first inlet and the second inlet are located on a bottom of the main body, the enter pipes communicate with the first inlet and the second inlet individually.

5. The faucet of claim 3, wherein the containing unit comprises a lower containing unit, the lower containing unit is located beneath the lateral outlet, an annular space is defined by the lower containing unit and the control valve assembly, the annular space communicates with the second channel and the second exit pipe.

6. A faucet, comprising the control valve assembly of claim 1, the faucet further comprising:
a multi-way pipe, having a containing unit, two enter pipes, a first exit end and a second exit end, the control valve assembly being positioned in the containing unit, the enter pipes communicating with the first inlet passage and the second inlet passage individually, the first exit end communicating with the lateral outlet, the second exit end communicating with the first exit end.

7. The faucet of claim 6, wherein the first inlet passage has a first inlet, the second inlet passage has a second inlet, the first inlet and the second inlet are located on a bottom of the main body, the enter pipes communicate with the first inlet and the second inlet individually.

8. The faucet of claim 6, wherein the containing unit comprises a lower containing unit, the lower containing unit is located under the lateral outlet, an annular space is defined by the lower containing unit and the control valve assembly, the annular space communicates with the second channel and the second exit end.
